(19) United States
(12) Patent Application Publication
(10) Pub. No.: US 2013/0124036 A1
(43) Pub. Date: May 16, 2013

(54) Wireless Onboard Diagnostic System

(71) Applicant: Real Time Companies, LLC, Phoenix, AZ (US)

(72) Inventors: Kenneth A. Varga, Peoria, AZ (US); John Hiett, Tempe, AZ (US)

(73) Assignee: Real Time Companies, LLC, Phoenix, AZ (US)

(21) Appl. No.: 13/674,811

(22) Filed: Nov. 12, 2012

Related U.S. Application Data
(60) Provisional application No. 61/629,007, filed on Nov. 12, 2011.

(51) Int. Cl. G01M 17/00

(52) U.S. Cl. CPC G01M 17/00
USPC 701/32.7

(57) ABSTRACT

A wireless onboard data bus system for aircraft, spacecraft, ships, or other vessel where data from the onboard bus or buses are transmitted to a mobile receiver for display and/or processing.

### CROSS-REFERENCE TO RELATED APPLICATIONS

This application claims priority from U.S. provisional application Ser. No. 61/629,007, filed Nov. 12, 2011.

### FIELD

This present disclosure relates generally to diagnostic instruments, and more particularly, to wireless diagnostic instrument systems for use with aircraft, spacecraft, naval vessels, and similar vehicles.

### BACKGROUND

Conventional computing devices, such as PCs and handheld computers, provide a convenient platform for communicating with diagnostic instrumentation. The computing devices enable a technician to use a diagnostic instrument quickly and easily. For example, in an automotive service facility, a handheld computing device can be easily connected to a vehicle's on-board diagnostic system for testing or problem diagnosis.

Although handheld computing devices offer portability and flexibility, the diagnostic instruments with which they are designed to work typically require serial communication cables or other wireline infrastructure to communicate. Consequently much of a handheld computing device's portability is compromised when it must be coupled to a wireline interface.

In addition, a technician may use several diagnostic instruments when diagnosing a problem or evaluating a vehicle's performance. Typically each of these diagnostic instruments requires various wireline connections to the computing device. Many such connections can become cumbersome for the technician to manage. An improper or incorrect connection may cause the computing device to malfunction or to provide inaccurate information and, therefore, consume diagnostic or repair time needlessly.

The foregoing description is derived primarily from U.S. Pat. No. 7,225,064, which discloses the use of a wireless communications device to communicate between a computing device and diagnostic instruments. See also, U.S. Pat. No. 6,732,031, incorporated herein by reference, which discusses the use of wireless technology in an onboard diagnostic system. Many available diagnostic systems now use wireless technology in limited circumstances. However, there is currently no solution that provides sufficiently reliable wireless solutions for diagnostic applications as part of a moving platform, such as a vehicle, where the wireless communications are likely to encounter significant interference.

### SUMMARY

The present disclosure provides a system and method for capturing onboard data bus information for diagnostics, instrumentation, or other useful data for real time fault analysis, or otherwise, filtering this data, and retransmitting the filtered data wirelessly to a receiver where the data can be processed and/or displayed. The filter can be set by the end user or programmatically such that only data needed by the end user is provided as needed.

Other systems, methods, features, and advantages of the present disclosure will be or become apparent to one with skill in the art upon examination of the following drawings and detailed description. The features, functions and advantages that have been discussed can be achieved independently in various examples of the present invention or may be combined in yet other examples further details of which can be seen with reference to the following description and drawings.

### BRIEF DESCRIPTION OF THE FIGURES

Many aspects of the present disclosure can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a schematic of a wireless onboard diagnostic data system applied on a moving platform in accordance with one example of the present disclosure; and

FIG. 2 is an illustration of a wireless diagnostic or instrument filtering data system onboard an aircraft, in accordance with another example of the present disclosure.

### DETAILED DESCRIPTION

In the following description, reference is made to the accompanying drawings, which form a part hereof, and in which is shown, by way of illustration, various embodiments of the present disclosure. It is understood that other embodiments may be utilized and changes may be made without departing from the scope of the present disclosure.

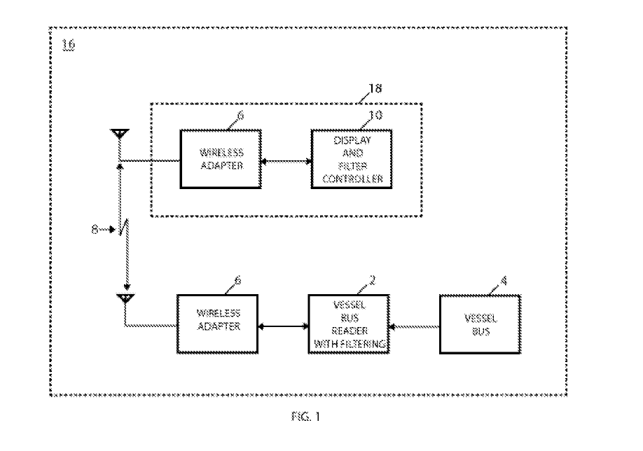

FIG. 1 shows a general vessel 16 wireless onboard diagnostic data filtering system. Vessel bus 4 is shown connected to vessel bus reader with filtering device 2. Data that is filtered either by setting or other means is sent from vessel bus reader with filtering device 2 to the wireless adapter 6 where wireless signal 8 is used to transfer messages between wireless adapters 6 where display and filter controller 10 displays and enables control of filtered data and filter settings in computer system 18. While data flow from vessel bus 4 and vessel bus reader is shown as only one way to improve security and safety of vessel bus 4, however, the communications can be configured in both directions if desired.

Filtering device 2 may be designed according to the needs of a particular application, and may include new technology. For example, the filtering device may comprise a multi-channel space-time filter circuit. The filtering device may also include Downlink Advanced Receiver Performance (DARP) capability, Bluetooth capability, or other wireless communications capability. Some examples of the filtering device may include a Kalman filter, which can be useful to distinguish the diagnostic signals from other aircraft operation signals.

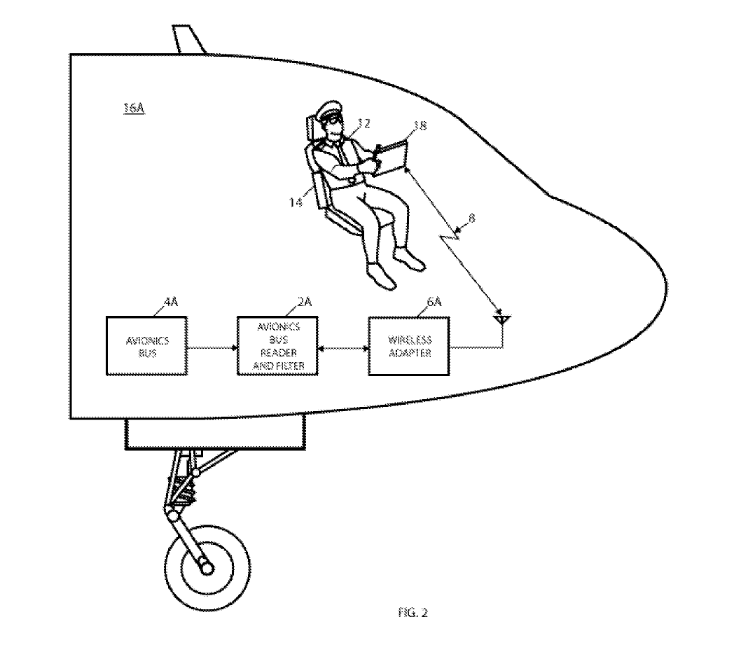

FIG. 2 shows a specific example of a wireless onboard diagnostic data filtering system as applied to an airplane. An aircraft 16A application of the onboard wireless diagnostic filtering system is shown with a pilot user 12 sitting in a flight deck chair 14 is shown holding a wireless computer system 18 that can display processed data from avionics bus 4A. The onboard avionics bus 4A data gets to computer system 18 by reading and filtering the avionics bus or busses 4A by avionics bus reader and filter 2A and is then transmitted through avionics wireless adapter 6A to wireless computer system 18 via wireless signal 8.

Computer system 18 may function as a user display, as well as perform the function of processing the data received via wireless signal 8.

In operation, the wireless onboard data bus system captures data off of the bus hardware for the vessel, sends this data to a wireless adapter where it is transmitted wirelessly to a receiver where the data is processed and/or displayed.

It should be emphasized that the above-described embodiments of the present device and process are merely possible examples of implementations and merely set forth for a clear understanding of the principles of the disclosure. Many different examples of the disclosure described herein may be designed and/or fabricated without departing from the spirit and scope of the disclosure. All these and other such modifications and variations are intended to be included herein within the scope of this disclosure and protected by the following claims. Therefore the scope of the disclosure is not intended to be limited except as indicated in the appended claims.

1. A wireless onboard data bus system for a moving platform, comprising:
a data bus reader
a data filtration system
a wireless adapter
a wireless receiver; and
a computing device.

2. The system of claim 1, further comprising a user display.

3. The system of claim 1, wherein the system is contained entirely on the moving platform.

4. The system of claim 1, wherein the data bus reader is an avionics bus reader with filtering.

5. The system of claim 1, wherein the data filtration system comprises a kalman filter.

6. The system of claim 1, wherein the moving platform comprises one of a group consisting of an aircraft, a naval vessel, an automobile, or a spacecraft.
